(19) United States
(12) Patent Application Publication
(10) Pub. No.: US 2010/0306027 A1
(43) Pub. Date: Dec. 2, 2010

(54) Net-Metering In A Power Distribution System

(75) Inventor: Julianne F. Haugh, Austin, TX (US)

Correspondence Address: INTERNATIONAL CORP (BLF), c/o BIGGERS & OHANIAN, LLP, P.O. BOX 1469, AUSTIN, TX, 78767-1469, US

(73) Assignee: INTERNATIONAL BUSINESS MACHINES CORPORATION, Armonk, NY (US)

(21) Appl. No.: 12/476,391

(22) Filed: Jun. 2, 2009

(51) Int. Cl. G06Q 10/00; G06F 1/28; G06F 17/30

(52) U.S. Cl. 705/10; 700/291; 707/E17.044

(57) ABSTRACT

net-metering in a power distribution system that includes a DRG system that is capable of providing power to a local load, an electric utility, and one or more batteries for storage, where net-metering is carried out iteratively during operation of the power distribution system and includes: creating, by a decision control engine, a local load and generation profile for a predefined period of time; deciding, by the decision control engine in accordance with revenue optimizing decision criteria and in dependence upon the local load and generation profile, present and projected utility power purchase prices, and a present state of charge of the batteries, whether to sell or store locally generated power; providing locally generated power to the electric utility if the decision control engine decides to sell locally generated power; and charging batteries with locally generated power if the decision control engine decides to store locally generated power.

### BACKGROUND OF THE INVENTION

1. Field of the Invention

The field of the invention is data processing, or, more specifically, methods, apparatus, and products for net-metering in a power distribution system.

2. Description of Related Art

Today, electricity for loads such as residential housing, commercial businesses, industrial plants, and so on may be generated by multiple different sources. One source of electricity is the traditional electric utility. Another possible source is an on-site power source, such as a distributed renewable generation (‘DRG’) system. In some cases, the DRG system and utility share the responsibility of generating power for a load. Further, the DRG system may be configured to provide power, generated by the DRG system, to the utility itself. In such systems in which power generated by a DRG system is provided to a utility, net-metering is carried out. Net-metering generally is an electricity policy that specifies that a DRG system owner receives, from a utility, one or more credits for at least a portion of electricity generated by the DRG system and provided to the utility.

Present net-metering schemes for such DRG systems operate in one of two modes. In the first mode, a bi-directional electricity meter, called a net-meter, runs forward when power demand from the load exceeds power generation by the DRG system and runs backwards when power generation by the DRG system exceeds demand from the load and the excess power is provided to the utility. In such a mode, the net-meter may run backward and forward in such a manner as to provide the DRG system owner, one-for-one credit for unity of electricity produced by the DRG system. In the second mode, two meters are used and credit for the units of electricity produced by the DRG system differs from the price paid to the utility for units of electricity provided to the local load. Demand on the electric utility may vary greatly throughout a day, increasing or decreasing the value of power provided to the utility accordingly. In these two prior art modes of net-metering, however, power generated by a local DRG system is not provided to the utility in a manner in which revenue in providing the power to the utility is optimized.

### SUMMARY OF THE INVENTION

Methods, apparatus and products for net-metering in a power distribution system that includes a distributed renewable generation (‘DRG’) system are described here. Such DRG systems are capable of providing power to a local load, an electric utility, and one or more batteries for storage. Net-metering according to embodiments of the present invention is carried out iteratively during operation of the power distribution system, and includes creating, by a decision control engine, a local load and generation profile for a predefined period of time, the local load and generation profile describing projected net local power generation for the predefined period of time; deciding, by the decision control engine in accordance with revenue optimizing decision criteria and in dependence upon the local load and generation profile, present and projected utility power purchase prices, and a present state of charge of the batteries, whether to sell or store locally generated power; providing locally generated power to the electric utility if the decision control engine decides to sell locally generated power; and charging batteries with locally generated power if the decision control engine decides to store locally generated power.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an exemplary power distribution system for which net-metering is carried out according to embodiments of the present invention.

FIG. 2 sets forth a flow chart illustrating an exemplary method for net-metering in a power distribution system according to embodiments of the present invention.

FIG. 3 sets forth a flow chart illustrating a further exemplary method for net-metering in a power distribution system according to embodiments of the present invention.

FIG. 4 sets forth a method of deciding whether to sell or store locally generated power in accordance with revenue optimizing decision criteria.

### DETAILED DESCRIPTION OF EXEMPLARY EMBODIMENTS

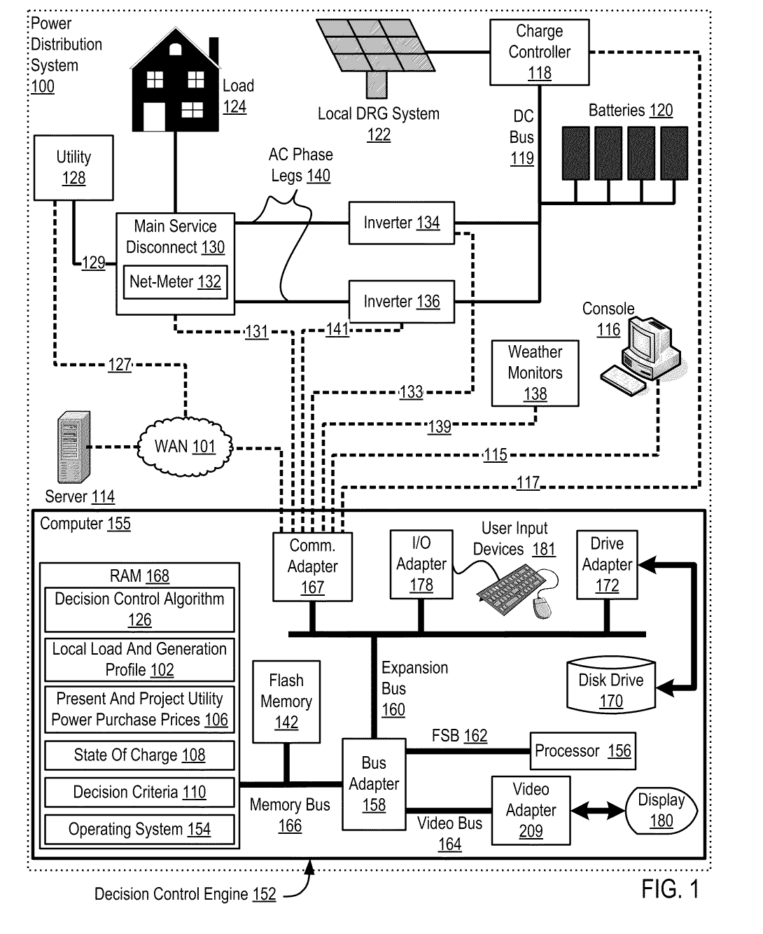

Exemplary methods, apparatus, and products for net-metering in a power distribution system in accordance with the present invention are described with reference to the accompanying drawings, beginning with FIG. 1. FIG. 1 sets forth a block diagram of an exemplary power distribution system (100) for which net-metering is carried out according to embodiments of the present invention. A power distribution system (100) as term is used in this specification is a collection of computer hardware, computer software, machinery, and other components that distributes power from one or more sources to one or more loads, where at least one source is a distributed renewable generation (‘DRG’) system. The example power distribution system (100) of FIG. 1 includes a local renewable generation (‘DRG’) system (122) that is capable of providing power to a local load (124), an electric utility (128), and one or more batteries (120) for storage. DRG systems are power generation technologies that provide an alternative to or an enhancement of traditional electric utility power systems. DRG systems are described as ‘renewable’ when resources used to generate power in the system are renewable resources such as wind, solar power, and water. Examples of DRG systems useful in power distribution systems in which net-metering is carried out according to embodiments of the present invention include photovoltaic (‘PV’) systems, micro-hydroelectric systems, and wind turbine systems.

The example DRG system (112) in FIG. 1 is depicted as a ‘local’ DRG system, so described because the DRG system is maintained and operated by and for the benefit of the owner of the power distribution system in contrast to DRG systems located and operated by other entities. ‘Local’ here may also mean that the DRG system is physically located near the load to which the DRG system provides power, but such a limitation on location is not necessary. That is, a local DRG system in a power distribution system for which net-metering is carried out in accordance with embodiments of the present invention may be physically located near the load to which the DRG system provides power or not.

Net-metering is an electricity policy that specifies that a DRG system owner receives, from a utility, one or more credits for at least a portion of electricity generated by the DRG system and provided to the utility. That is, a utility pays a DRG system owner for electricity received by the utility and generated by the owner's DRG system. In prior art, such ‘payment’ was carried out by literally spinning an electricity meter backwards for power generated by a DRG system and provided to the utility. Such bi-directional meters are referred to as net-meters (132).

A local load (124) is an electrical load, a consumer of power. The local load (124) in the example of FIG. 1 receives operational power, typically AC power; through the main service disconnect (130). A main service disconnect is a switch that when open, disconnects the load (124) from power provided by the utility (128). Although not shown here for clarity, readers of skill in the art will recognize that other electrical distribution components may be connected to the main service disconnect (130) for distributing power to the load (124) such as line conditioners, circuit breakers, and the like. The main service disconnect in the example of FIG. 1 is provided power to distribute to the load (124) from two sources: an electric utility (128) through power line (129) and the local DRG system (122) through the charge controller (118), Direct Current (‘DC’) bus (119), power inverters (134, 136), and phase legs (140).

Installed as part of the main service disconnect (132) is a net-meter (132). Readers of skill in the art will recognize that inclusion of the net-meter as part of the main service disconnect (130) is for purposes of clarity not limitation, a net-meter used in accordance with embodiments of the present invention may be configured as a stand alone device, a component separate and apart from the main service disconnect. A net-meter is device that meters net-electricity distributed through the main service disconnect to the load. The term ‘net’ here refers to the difference in power provided to the load (124) from the utility and locally generated power provided to the load and provided to the utility along power line (129). Locally generated power as the term is used in this specification refers, as context requires, to any power generated by a local DRG system (122) in a power distribution system (100), whether that power is currently generated and not stored or the power was previously generated and stored in the batteries.

A charge controller (118) is a device that limits the rate at which electric current generated by the local DRG system (122) is added to or drawn from electric batteries along the DC bus (119). The example charge controller (118) is configured to monitor the battery's present state of charge. The term ‘state of charge’ as used in this specification may refer to either or both of a relative state of charge with respect to total battery capacity, such as 90% charged, or a present battery capacity, such as 24 KW of a 26.7 KW battery, as context requires.

The power inverters (134, 136) are configured to convert DC power into AC power.

The inverters in the example of FIG. 1 are grid-tie inverters: inverters that monitor AC supply waveforms from the utility (128) along power line (129), also referred to as ‘mains,’ and invert DC power from the local DRG system to AC power in phase with the AC supply for supply to a load (124) and the utility (128). The example power inverters (134, 136) of FIG. 1 are configured to sense AC production along the phase legs.

The example system (100) of FIG. 1 also includes a decision control engine (152). A decision control engine (152) is a module of automated computing machinery that carries out net-metering in a power distribution system (100) in accordance with embodiments of the present invention. That is, a decision control engine (152) may be implemented as an aggregation of computer hardware and software. In the example of FIG. 1, the decision control engine (152) is implemented as a computer (155) that includes at least one computer processor (156) or ‘CPU’ as well as random access memory (168) (‘RAM’) which is connected through a high speed memory bus (166) and bus adapter (158) to processor (156) and to other components of the computer (155).

The exemplary computer (155) of FIG. 1 includes a communications adapter (167) for data communications with other computers, with a data communications network, wide area network (‘WAN’) (101), and with the following devices:
the electric utility (128) connected through the WAN (101) and data communications connection (127) to the computer (155);
the main service disconnect (130) through data communications connection (131);
the inverter (136) through data communications connection (141);
the inverter (134) through data communications connection (133);
the weather monitors (138) through data communications connection (139);
the console (116) through data communications connection (115); and
the charge controller (118) through data communications connection (117).

Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for net-metering in a power distribution system (100) according to embodiments of the present invention include modems for wired dial-up communications, Ethernet (IEEE 802.3) adapters for wired data communications network communications, and 802.11 adapters for wireless data communications network communications. In this example, each of the above devices is connected to the computer (155) for data communications through the communications adapter (167) for clarity of explanation, not limitation. Readers of skill in the art will immediately recognize that such devices may be connected to the computer (155) for data communications in other ways, through other network types, through different adapters, through out-of-band buses, and so on.

Stored in RAM (168) of the computer (155) is a decision control algorithm, a module of computer program instructions that when executed operates the computer (155) as a decision control engine (152) for net-metering in the power distribution system (100) of FIG. 1 in accordance with embodiments of the present invention. Net-metering in embodiments of the present invention is carried out iteratively during operation of the power distribution system (100). The decision control engine (152) of FIG. 1 carries out such net-metering in the example power distribution system (100) in accordance with embodiments of the present invention by creating a local load and generation profile (102) for a predefined period of time; and deciding, in accordance with revenue optimizing decision criteria (110) and in dependence upon the load and generation profile (102), present and projected utility power purchase prices (106), and a present state of charge of the batteries (108), whether to sell or store locally generated power; providing locally generated power to the electric utility (128) if the decision control engine (152) decides to sell locally generated power; and charging batteries (120) with locally generated power if the decision control engine (152) decides to store locally generated power.

Utility power purchase prices (106) refer to the price a utility offers a power distribution system owner for electricity generated by a local DRG system in the power distribution system. Price here, may refer to actual price, in dollars and cents, or credits of power, such that 1 kilowatt-hour (kWh) of locally generated power purchased by utility is credited as 0.025 kWh of power from the utility. Present utility power purchase prices are prices for locally generated power presently provided to the utility while projected utility power purchase prices are forecasted prices based on historical demand for locally generated power provided to the utility at a later time. Such projected prices may vary continuously with demand on a utility. Such prices may be retrieved from the utility (128) itself, from a server (114) hosting such data, from a database of historical price data, and in other ways as will occur to readers of skill in the art.

A load and generation profile (102) as the term is used here is one or more data structures including information describing projected net local power generation for the predefined period of time. The profile (102) is said to include information describing projected ‘net’ local power generation in that, at least in some embodiments, the information includes the difference in power generated by the local DRG system (122) and power consumed by the load (124)—that amount available for storing in the batteries or selling to the utility. The load and generation profile may be created for particular weather condition, present and projected, over a predefined period of time, also called a time-window or window of time in this specification. Weather conditions, such as a cloudy day or high temperature, may vary power generation of a local DRG system and power consumption by a local load. Consider the following table as an example data structure forming a load and generation profile:

TABLE 1
Load and Generation Profile (102) For Monday, With Weather
Conditions Being Sunny, And A Starting Temperature
of 50 Degrees Fahrenheit

| | Power | Power | | Running Total |
|---|---|---|---|---|
| | Consumed By | Generated By | Net Power | of Net Power |
| Time | Load | DRG system | Generated | Generated |
| 9:00 | 354 | 722 | 368 | 368 |
| 10:00 | 358 | 912 | 554 | 922 |
| 11:00 | 503 | 1224 | 721 | 1643 |
| 12:00 | 579 | 1552 | 973 | 2616 |
| 13:00 | 531 | 1489 | 958 | 3574 |
| 14:00 | 531 | 1353 | 822 | 4396 |
| 15:00 | 663 | 1020 | 357 | 4753 |
| 16:00 | 516 | 716 | 200 | 4953 |
| 17:00 | 455 | 136 | −319 | 4634 |
| 18:00 | 452 | 0 | −452 | 4182 |
| 19:00 | 453 | 0 | −453 | 3729 |
| 20:00 | 453 | 0 | −453 | 3276 |
| 21:00 | 628 | 0 | −628 | 2648 |
| 22:00 | 750 | 0 | −750 | 1898 |
| 23:00 | 623 | 0 | −623 | 1275 |

The table above is an example of a load and generation profile (102) for a Monday, in which weather conditions are projected to be sunny and the present temperature when the load and generation profile was created was 50 Degrees Fahrenheit. The profile includes several records, each record specifying, for a particular hour of a day, projected or estimated power consumed by a load, the projected power generated by the DRG system, the net power generated, and a running total of the net power generated by the DRG system. The example load and generation profile (102) depicted in Table 1 is a single table for clarity of explanation only. Readers of skill in the art will immediately recognize that such load and generation profiles useful in net-metering according to embodiments of the present invention may be made up of any number of data structure or any number of tables, records, columns, data types and so on.

As mentioned above, current and projected weather conditions may vary power generation by a local DRG system and power consumption by a local load and as such the load and generation profile may be generated in dependence upon such weather conditions as well as historical load and generation data. The decision control engine (152) may retrieve such current and projected weather conditions from many different sources, such as for example, from local weather monitors (138) through data communications connection (139), from a server (114) hosting weather data through a wide area network (101), and so on as will occur to readers of skill in the art. Weather monitors (138) may be implemented in as a variety of devices such as rain gauges, barometers, thermometers, hygrometers, and so on as will occur to readers of skill in the art.

The decision control engine (152) may create a load and generation profile in various ways in dependence upon various data. Consider, as one example way of creating a load and generation profile, that a user, such as the power distribution system (100) owner, enters, through user input devices connected to a console, estimated, or previously measured, load and generation values which are transmitted to the decision control engine over data communications connection (115) where they are stored and later used to create a load and generation profile. Consider, as another example of a way to create a load and generation profile, that the decision control engine (152) may create the profile with historical load and generation data maintained in a DRG database. Such a DRG database may be stored in a disk drive (170) internal to the computer (155), an external disk drive, in flash memory (142), in a server connected to the computer (155) through a data communications network, or in other computer memory as will occur to readers of skill in the art. Maintaining a DRG database of historical load and generation data may include tracking, in the DRG database (310): local present weather conditions through the weather monitors (138) and data communications connection (138), local power generation and the present state of charge of the batteries (120) through the charge controller (118) and data communications connection (117), the local load (122) through the net-meter (132), and the local AC production through the inverters (134, 136) and data communications connections (133, 141).

The decision control engine (152) decides whether to sell or store locally generated power in accordance with revenue optimizing decision criteria (110) Revenue optimizing decision criteria (110) are rules that govern or specify the decision control engine's (152) decision making process. Examples of such revenue optimizing decision criteria (110) include rules that specify that the decision control engine (152) is to decide to sell locally generated power when the present state of charge of the batteries is greater than a maximum threshold, rules that specify that the decision control engine is to store locally generated power when the present state of charge of the batteries is less than a minimum threshold; rules that specify that the decision control engine is to decide to sell locally generated power to reach a target state of charge at the time of the maximum price within a predefined period of time when the DRG is capable of generating and storing power to reach the target state of charge at the time of maximum utility power purchase price within the predefined period of time and the present state of charge is between the maximum and minimum threshold; rules that specify that the decision control engine is to decide to sell locally generated power to the utility when the DRG is not capable of generating and storing such power to reach the target state of charge and the present utility power purchase price is greater than one or more projected selling prices and the present state of charge is between the maximum and minimum threshold; rules that specify that the decision control engine is to decide to store locally generated power in the batteries when the DRG is not capable of generating and storing such power to reach the target state of charge and the present utility power purchase price is not greater than one or more projected selling prices and the present state of charge is between the maximum and minimum threshold; and so on as will occur to readers of skill in the art.

The decision control engine (152) of FIG. 1 provides locally generated power to the electric utility (128) by instructing the charge controller (118) through data communications connection (118) to divert some or all power generated by the local DRG system (122) along the DC bus (119) to the inverters (134, 136) rather than to the batteries (120), and configuring the inverters (134, 136) through data communications connections (131, 141) to invert the DC power to AC power along the AC phase legs (140). The decision control engine (152) of FIG. 1 charges batteries (120) with locally generated power by instructing the charge controller (118) through data communications connection (118) to divert some or all power generated by the local DRG system (122) to the batteries (120) along the DC bus (119) rather than to the inverters (134, 136) and configuring the inverters (134, 136) through data communications connections (131, 141) to not invert the DC power from the DC bus to AC power along the AC phase legs (140). Such data communications between the decision control engine (152) and the inverters and charge controller may be in any form of data communications as will occur to readers of skill in the art such as, for example, Transistor-Transistor Logic (‘TTL’) level control signals or more complex packet-based communication.

Also stored in RAM (168) is an operating system (154). Operating systems useful net-metering in a power distribution system (100) according to embodiments of the present invention include UNIX™, Linux™, Microsoft XP™, AIX™, IBM's i5/OS™, and others as will occur to those of skill in the art. The operating system (154), decision control algorithm (126), local load and generation profile (102), present and projected utility power purchase prices (106), the present state of charge (108) of the batteries (120), and the revenue optimizing decision criteria (110) in the example of FIG. 1 are shown in RAM (168), but many components of such software typically are stored in non-volatile memory also, such as, for example, on a disk drive (170).

The computer (155) of FIG. 1 includes disk drive adapter (172) coupled through expansion bus (160) and bus adapter (158) to processor (156) and other components of the computer (155). Disk drive adapter (172) connects non-volatile data storage to the computer (155) in the form of disk drive (170). Disk drive adapters useful in computers for net-metering in a power distribution system (100) according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory, such as ‘EEPROM’ or ‘Flash’ memory (142), RAM drives, and so on, as will occur to those of skill in the art.

The example computer (155) of FIG. 1 also includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (155) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The decision control engine (152) is implemented in the example system (100) of FIG. 1 as a standalone computer (155) for clarity of explanation only, not limitation. Readers of skill in the art will immediately understand that such a computer, or operative components of the computer, may be implemented as part of another component in the power distribution system (100) such as, for example, the net-meter (132), inverters (134, 136), and so on.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

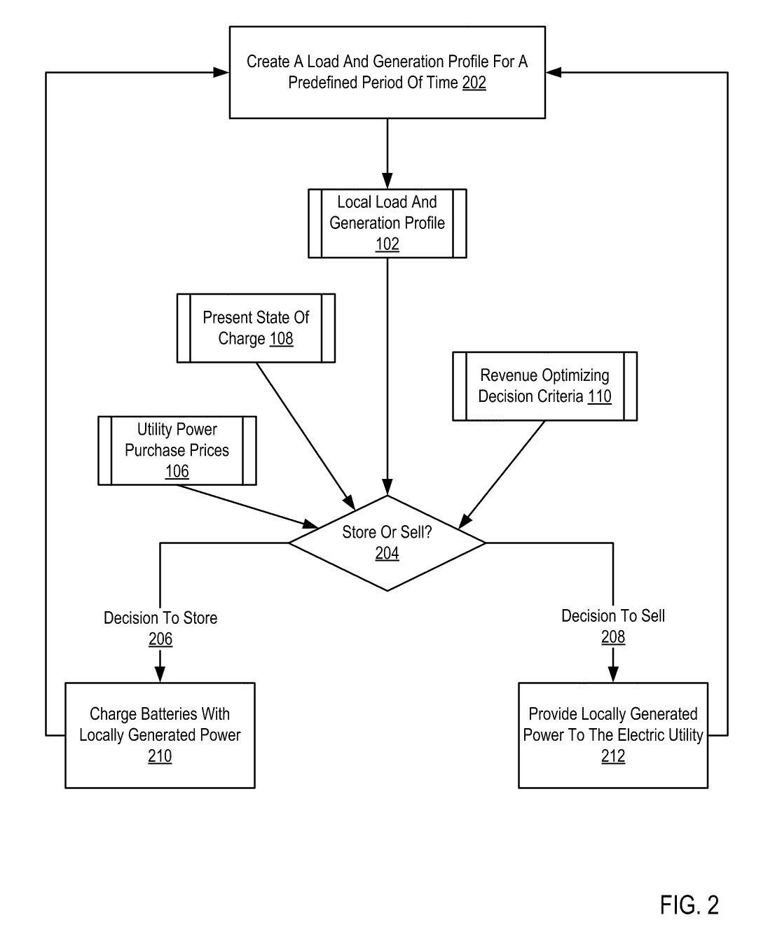

For further explanation, FIG. 2 sets forth a flow chart illustrating an exemplary method for net-metering in a power distribution system according to embodiments of the present invention. The method of FIG. 2 is carried out by a decision control engine similar to the decision control engine (152) depicted in FIG. 1. The method of FIG. 2 is also carried out in a power distribution system similar to that depicted in FIG. 1, system (100). The power distribution system (100 on FIG. 1) includes a distributed renewable generation (‘DRG’) system (122 on FIG. 1) where the DRG system (122 on FIG. 1) is capable of providing power to a local load (124 on FIG. 1), an electric utility (128 on FIG. 1), and one or more batteries (120 on FIG. 1) for storage.

The method of FIG. 2 is carried out iteratively during operation of the power distribution system (100 on FIG. 1). The method is said to be carried out iteratively during operation of the power distribution system (100 on FIG. 1) in that a first decision to store or sell locally generated power is made and carried out, a subsequent decision to store or sell locally generated power is made and carried out, then another decision to store is sell locally generated power is made and carried out, and so on.

These iterations may occur upon a predetermined time interval, say every 20 seconds, or continuously, as soon as a previous iteration completes.

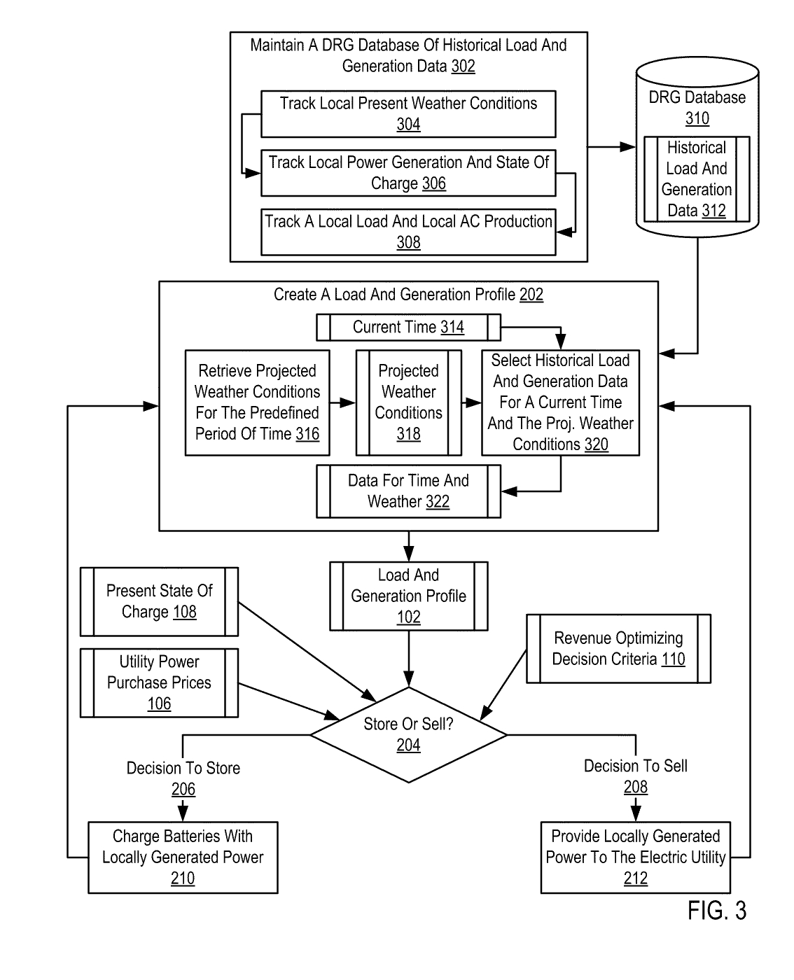

The method of FIG. 2 includes creating (202), by a decision control engine (152 of FIG. 1), a local load and generation profile (102) for a predefined period of time. The local load and generation profile (102) describes projected net local power generation for the predefined period of time. Creating (202) a local load and generation profile (102) for a predefined period of time may be carried out in various ways as described below with respect to FIG. 3.

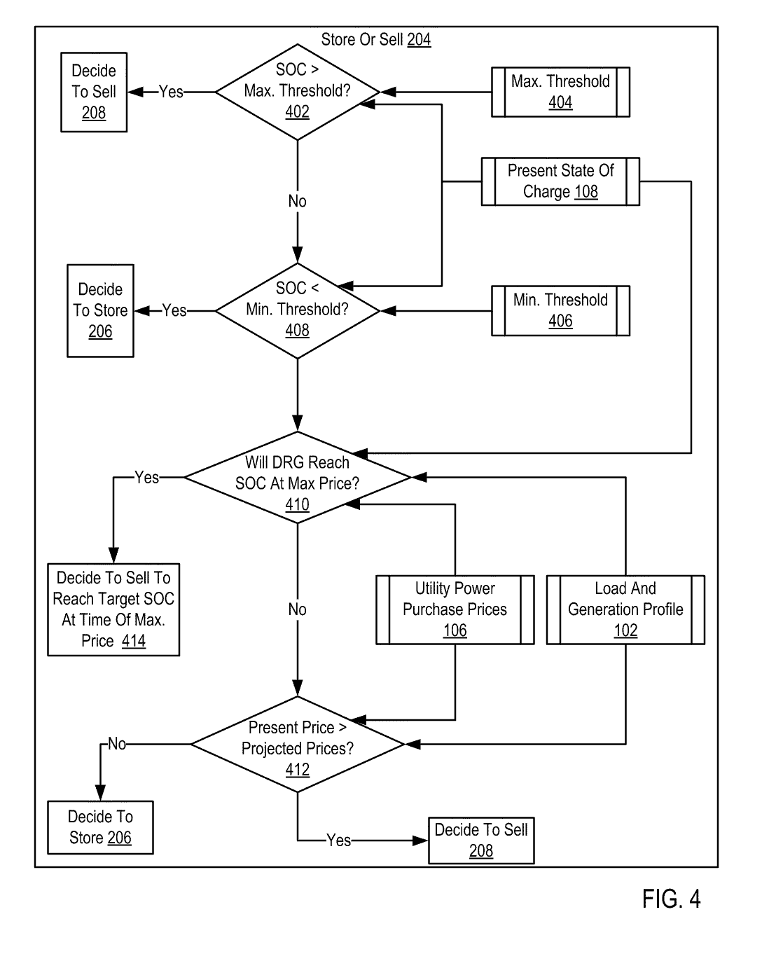

The method of FIG. 2 also includes deciding (204), by the decision control engine in accordance with revenue optimizing decision criteria (110) and in dependence upon the local load and generation profile (102), present and projected utility power purchase prices (106), and a present state of charge (108) of the batteries, whether to sell or store locally generated power. Deciding (204) whether to sell or store locally generated power may be carried out in various ways as explained below in more detail with respect to FIG. 4.

If the decision control engine decides to sell (208) locally generated power, the method of FIG. 2 continues by providing (212) locally generated power to the electric utility (128 on FIG. 1). Providing (212) locally generated power to the electric utility (128 on FIG. 1) may be carried out by instructing a charge controller (118 on FIG. 1) to divert some or all power generated by the local DRG system along the DC bus to inverters rather than to batteries and configuring the inverters (134, 136 on FIG. 1) to invert the DC power to AC power.

If the decision control engine decides to store (206) locally generated power, the method of FIG. 2 continues by charging (210) batteries (120 on FIG. 1) with locally generated power. Charging (210) batteries (120 on FIG. 1) with locally generated power may be carried out by instructing the charge controller (118 on FIG. 1) to divert some or all power generated by the local DRG system to the batteries along a DC bus rather than to the inverters (134, 136 on FIG. 1) and configuring the inverters (134, 136 on FIG. 1) to not invert the DC power from the DC bus to AC power along the AC phase legs (140).

For further explanation, FIG. 3 sets forth a flow chart illustrating a further exemplary method for net-metering in a power distribution system according to embodiments of the present invention. The method of FIG. 3, like the method of FIG. 2, is carried out by a decision control engine similar to the decision control engine (152) depicted in FIG. 1 and in a power distribution system similar to the system (100) depicted in FIG. 1. The power distribution system (100 on FIG. 1) includes a distributed renewable generation (‘DRG’) system (122 on FIG. 1) where the DRG system (122 on FIG. 1) is capable of providing power to a local load (124 on FIG. 1), an electric utility (128 on FIG. 1), and one or more batteries (120 on FIG. 1) for storage. The method of FIG. 3, like the method of FIG. 2, is carried out iteratively during operation of the power distribution system (100 on FIG. 1).

The method of FIG. 3 is also similar to the method of FIG. 2 in that the method of FIG. 3 includes creating (202) a local load and generation profile (102) for a predefined period of time, deciding (204) whether to sell or store locally generated power, providing (212) locally generated power to the electric utility (128 on FIG. 1) if the decision control engine decides to sell (208) locally generated power, and charging (210) batteries (120 on FIG. 1) with locally generated power if the decision control engine decides to store (206) locally generated power.

The method of FIG. 3 differs from the method of FIG. 2, however, in that the method of FIG. 3 includes maintaining (302) a DRG database (310) of historical load and generation data (312). In the method of FIG. 3, maintaining (302) a DRG database (310) of historical load and generation data (312) may be carried out by tracking (304), in the DRG database (310), local present weather conditions; tracking (306), in the DRG database (308), local power generation and state of charge; and tracking (308), in the DRG database (308), a local load and local Alternating Current (‘AC’) production.

Tracking local present weather conditions may be carried out by retrieving data representing local present weather conditions from weather monitors (138 on FIG. 1) operating within the power distribution system. Tracking local power generation and the present state of charge of the batteries may be carried out by retrieving data representing such power generation and state of charge from a charge controller (118 on FIG. 1) operating within the power distribution system. Tracking the local load (122) may be carried out by retrieving data representing the local load from a net-meter (132 on FIG. 1) operating in the power distribution system. Tracking local AC production may be carried out by retrieving data representing such local AC production from one or more inverter (134, 136 on FIG. 1) operating in the power distribution system. Upon retrieving data representing each of these parameters, the decision control engine may store the data in the database.

In the method of FIG. 3, creating (202) the local load and generation profile for the predefined period of time is carried out by retrieving (316) projected weather conditions (318) for the predefined period of time and selecting (320), from the DRG database (310), historical load and generation data (322) for the predefined period of time beginning at the current time (314) and the projected weather conditions (318). Retrieving (316) projected weather conditions (318) for the predefined period of time may be carried out in various ways including, for example, by requesting the projected weather conditions from a server hosting such data via a wide area network, by retrieving previously stored data entered by a power distribution system user through a console, by calculating the prices through estimations of power demand provided by an organization such as ERCOT (Electricity Reliability Council of Texas), and in other ways as will occur to readers of skill in the art.

Selecting (320), from the DRG database (310), historical load and generation data (322) for the predefined period of time beginning at the current time (314) and the projected weather conditions (318) may be carried out in various ways. Readers of skill in the art will recognize many ways to retrieve data from a database including, database queries, sorting and filtering records of the database and so on. Readers will also understand that data in a database, such as the example DRG database (310), may be maintained so as to optimize retrieval of such data. Consider, as an example of database maintenance used to optimize retrieval of data, that historical load and generation data may be stored in so-called ‘weather buckets,’ associations between historical weather conditions and historical load and generation data, and statistical analysis may be performed on such data shortly after storage of that data. In this way any or most statistical analysis, a time consuming and processor intensive process, is complete prior to requesting data from the database. Storing and analyzing historical load and generation data in such a way optimizes retrieval of such data in that data matching a particular weather condition is quickly selected and no or limited statistical analysis need be performed upon a retrieval. That is, the data is effectively pre-filtered and pre-analyzed prior to retrieval.

As mentioned above with respect to FIG. 2, when net-metering according to embodiments of the present invention, deciding (204) whether to sell or store locally generated power may be carried out in various ways. For further explanation, therefore, FIG. 4 sets forth a method of deciding (204) whether to sell or store locally generated power in accordance with revenue optimizing decision criteria (110 on FIG. 2). Such revenue optimizing decision criteria (110 on FIG. 2), as explained above, are rules that govern or specify the decision control engine's decision making process, that is, rules that specify the steps of the method of FIG. 4.

The method of FIG. 4 includes determining (402) whether the present state of charge (108) is greater than a maximum threshold (404). The maximum threshold (404) may be a user-assigned value, dynamically calculated, or preset prior to installation and operation of the decision control engine. In some embodiments, the maximum threshold (404) represents a state of charge above which charging of the batteries enters an absorption charging stage as explained below in detail. If the present state of charge is greater than the maximum threshold (404), the method of FIG. 4 continues by deciding (208) to sell locally generated power.

If the present state of charge is not greater than the maximum threshold (404), the method of FIG. 4 continues by determining (408) whether the present state of charge (108) is less than a minimum threshold (406). If the present state of charge (108) is less than the minimum threshold (406), the method of FIG. 4 continues by deciding (206) to store locally generated power. In some embodiments of the present invention the minimum threshold is implemented as user-configurable threshold representing a state of charge below which any locally generated power must be stored in order to provide local reserve power, a typical function of batteries in a power distribution system that includes a DRG system.

If the present state of charge is not less than the minimum threshold, the present state of charge is between the minimum (406) and maximum (404) threshold and the method of FIG. 4 continues by predicting (410) whether the DRG system will generate and store power to reach a target state of charge at a time of maximum utility power purchase price within the predefined period of time. Predicting (410) whether the DRG system will generate and store power to reach a target state of charge at a time of maximum utility power purchase price within the predefined period of time may be carried out by determining from the local load and generation profile (102) whether the quantity of projected net power generation indicated in the load and generation profile equals or exceeds the quantity of power generation required to store power to reach the target state.

A target state of charge is a state of charge above which charging of the batteries enters an absorption charging stage. An absorption charging stage is a charging stage during which charging voltage is held constant and charging current is reduced over time, thereby reducing a rate at which locally generated power is stored in the batteries. During the absorption charging stage then, power generated by the DRG and not used by the system is inefficiently stored in batteries in comparison to power generated by the DRG and stored prior to entering the absorption charging state. Such inefficient storage is referred to as ‘spilling’ power—some power generated by the DRG system is neither used nor stored.

A maximum utility power purchase price is the highest utility power purchase price within the predefined period of time. Although there may be other peak prices during the predefined period of time, the maximum utility power purchase price is the greatest of all peaks during the predefined period of time. Selling power to the utility at this time, the time of maximum utility purchase price, optimizes revenue of selling locally generated power to the utility.

If the DRG system will generate and store power to reach the target state of charge at the time of maximum utility power purchase price within the predefined period of time, the method of FIG. 4 continues by deciding (414) to sell locally generated power to reach the target state of charge at the time of the maximum price within the predefined period of time. The phrase ‘to reach the target state of charge’ as used here describes a particular method of selling locally generated power to the utility, a method in which power is sold, during the predefined window of time, to optimize revenue of selling the power while attempting to reach the target state of charge at exactly, or nearly, the time of maximum utility power purchase price. Consider, for example, that the batteries in a power distribution system are capable of reaching the target state of charge well before the time of maximum utility power purchase price, say 5 hours before. Consider also, that during that five hours there are several times of peak utility power purchase prices, not the maximum, but peaks nonetheless. In the method of FIG. 4, the decision control engine decides to sell locally generated at such peak purchase prices, as long as the target state of charge can still be met, rather than charging the batteries to the target state of charge too early, and only selling when the state of charge is greater than the maximum threshold as described above. Selling the locally generated, stored power, when the state of charge is above the maximum threshold may reduce possible revenue over the 5 hour duration—selling at all times, whether peak price times or not. That is, selling locally generated power to reach the target state of charge may be carried out in an advantageous, revenue optimizing manner, selling at peak price times, not necessarily the maximum utility purchase price, but utility power purchase prices that are greater than the cost of purchasing from the utility.

If the DRG system will not generate and store power to reach the target state of charge at the time of maximum utility power purchase price within the predefined period of time, that is, if the decision control engine predicts that it is not possible to generate and store power to reach the target state of charge, the method of FIG. 4 continues by determining (412) whether the present utility power purchase price is greater than one or more projected selling prices. Projected selling prices refer to future, possible prices, called ‘projected’ here because in many embodiments utility power purchase prices may change throughout the day as actual grid demand varies from projected demand.

Determining (412) whether the present utility power purchase price is greater than one or more projected selling prices may be carried out by, identifying projected peak prices that are greater than the present cost to buy power from utility within the predefined period of time and comparing the present utility power purchase price with each of the peak prices. If the present utility power purchase price is greater than one or more projected utility power purchase prices, the method of FIG. 4 continues by deciding (208) to sell locally generated power to the utility. If the present utility power purchase price is not greater than the one or more projected utility power purchase prices, the method of FIG. 4 continues by deciding (206) to store locally generated power in the batteries.

Exemplary embodiments of the present invention are described largely in the context of a fully functional computer system for net-metering in a power distribution system. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of net-metering in a power distribution system comprising a distributed renewable generation (‘DRG’) system, the DRG system capable of providing power to a local load, an electric utility, and one or more batteries for storage, the method carried out iteratively during operation of the power distribution system, the method comprising:
creating, by a decision control engine, the decision control engine comprising a module of automated computing machinery, a local load and generation profile for a predefined period of time, the local load and generation profile describing projected net local power generation for the predefined period of time;
deciding, by the decision control engine in accordance with revenue optimizing decision criteria and in dependence upon the local load and generation profile, present and projected utility power purchase prices, and a present state of charge of the batteries, whether to sell or store locally generated power;
providing locally generated power to the electric utility if the decision control engine decides to sell locally generated power; and
charging batteries with locally generated power if the decision control engine decides to store locally generated power.

2. The method of claim 1 wherein deciding whether to sell or store locally generated power further comprises:
deciding to store locally generated power when present state of charge is below a minimum threshold.

3. The method of claim 1 wherein deciding whether to sell or store locally generated power further comprises:
deciding to sell locally generated power when present state of charge is above a maximum threshold.

4. The method of claim 1 wherein deciding whether to sell or store locally generated power further comprises:
if present state of charge is between a minimum and maximum threshold:
predicting whether the DRG system will generate and store power to reach a target state of charge at a time of maximum utility power purchase price within the predefined period of time;
if the DRG system will generate and store power to reach the target state of charge at the time of maximum utility power purchase price within the predefined period of time, deciding to sell locally generated power to reach the target state of charge at the time of the maximum price within the predefined period of time;
if the DRG system will not generate and store power to reach the target state of charge at the time of maximum utility power purchase price within the predefined period of time, determining whether the present utility power purchase price is greater than one or more projected selling prices;
if the present utility power purchase price is greater than one or more projected utility power purchase prices, deciding to sell locally generated power to the utility; and
if the present utility power purchase price is not greater than the one or more projected utility power purchase prices, deciding to store locally generated power in the batteries.

5. The method of claim 4 wherein the target state of charge further comprises a state of charge above which charging of the batteries enters an absorption charging stage, the absorption charging stage comprising a charging stage during which charging current is reduced over time and charging voltage is held constant thereby reducing a rate at which locally generated power is stored in the batteries.

6. The method of claim 1 further comprising:
maintaining a DRG database of historical load and generation data, including tracking, in the DRG database, local present weather conditions, tracking, in the DRG database, local power generation and state of charge, and tracking, in the DRG database, a local load and local Alternating Current (‘AC’) production;
wherein creating the local load and generation profile for the predefined period of time further comprises retrieving projected weather conditions for the predefined period of time and selecting, from the DRG database, historical load and generation data for the predefined period of time beginning at the current time and the projected weather conditions.

7. The method of claim 1 wherein the DRG system further comprises a photovoltaic (‘PV’) system.

8. The method of claim 1 wherein the DRG system further comprises a micro-hydroelectric system.

9. The method of claim 1 wherein the DRG system further comprises a wind turbine system.

10. Apparatus for net-metering in a power distribution system comprising a distributed renewable generation (‘DRG’) system, the DRG system capable of providing power to a local load, an electric utility, and one or more batteries for storage, the apparatus comprising a computer processor, a computer memory operatively coupled to the computer processor, the computer memory having disposed within it computer program instructions capable of, iteratively during operation of the power distribution system:
creating, by a decision control engine, the decision control engine comprising a module of automated computing machinery, a local load and generation profile for a predefined period of time, the local load and generation profile describing projected net local power generation for the predefined period of time;
deciding, by the decision control engine in accordance with revenue optimizing decision criteria and in dependence upon the local load and generation profile, present and projected utility power purchase prices, and a present state of charge of the batteries, whether to sell or store locally generated power;
providing locally generated power to the electric utility if the decision control engine decides to sell locally generated power; and
charging batteries with locally generated power if the decision control engine decides to store locally generated power.

11. The apparatus of claim 10 wherein deciding whether to sell or store locally generated power further comprises:
deciding to store locally generated power when present state of charge is below a minimum threshold; and
deciding to sell locally generated power when present state of charge is above a maximum threshold.

12. The apparatus of claim 10 wherein deciding whether to sell or store locally generated power further comprises:
if present state of charge is between a minimum and maximum threshold:
predicting whether the DRG system will generate and store power to reach a target state of charge at a time of maximum utility power purchase price within the predefined period of time;
if the DRG system will generate and store power to reach the target state of charge at the time of maximum utility power purchase price within the predefined period of time, deciding to sell locally generated power to reach the target state of charge at the time of the maximum price within the predefined period of time;
if the DRG system will not generate and store power to reach the target state of charge at the time of maximum utility power purchase price within the predefined period of time, determining whether the present utility power purchase price is greater than one or more projected selling prices;
if the present utility power purchase price is greater than one or more projected utility power purchase prices, deciding to sell locally generated power to the utility; and
if the present utility power purchase price is not greater than the one or more projected utility power purchase prices, deciding to store locally generated power in the batteries.

13. The apparatus of claim 12 wherein the target state of charge further comprises a state of charge above which charging of the batteries enters an absorption charging stage, the absorption charging stage comprising a charging stage during which charging current is reduced over time and charging voltage is held constant thereby reducing a rate at which locally generated power is stored in the batteries.

14. The apparatus of claim 10 further comprising computer program instructions capable of:
maintaining a DRG database of historical load and generation data, including tracking, in the DRG database, local present weather conditions, tracking, in the DRG database, local power generation and state of charge, and tracking, in the DRG database, a local load and local Alternating Current (‘AC’) production;
wherein creating the local load and generation profile for the predefined period of time further comprises retrieving projected weather conditions for the predefined period of time and selecting, from the DRG database, historical load and generation data for the predefined period of time beginning at the current time and the projected weather conditions.

15. The apparatus of claim 10 wherein the DRG system consists of one of:
a photovoltaic (‘PV’) system;
a micro-hydroelectric system; or
a wind turbine system.

16. A computer program product for net-metering in a power distribution system comprising a distributed renewable generation (‘DRG’) system, the DRG system capable of providing power to a local load, an electric utility, and one or more batteries for storage, the computer program product disposed in a computer readable recording medium, the computer program product comprising computer program instructions capable of, iteratively during operation of the power distribution system:
creating, by a decision control engine, the decision control engine comprising a module of automated computing machinery, a local load and generation profile for a predefined period of time, the local load and generation profile describing projected net local power generation for the predefined period of time;
deciding, by the decision control engine in accordance with revenue optimizing decision criteria and in dependence upon the local load and generation profile, present and projected utility power purchase prices, and a present state of charge of the batteries, whether to sell or store locally generated power;
providing locally generated power to the electric utility if the decision control engine decides to sell locally generated power; and
charging batteries with locally generated power if the decision control engine decides to store locally generated power.

17. The computer program product of claim 16 wherein deciding whether to sell or store locally generated power further comprises:
deciding to store locally generated power when present state of charge is below a minimum threshold; and
deciding to sell locally generated power when present state of charge is above a maximum threshold.

18. The computer program product of claim 16 wherein deciding whether to sell or store locally generated power further comprises:
if present state of charge is between a minimum and maximum threshold:
predicting whether the DRG system will generate and store power to reach a target state of charge at a time of maximum utility power purchase price within the predefined period of time;
if the DRG system will generate and store power to reach the target state of charge at the time of maximum utility power purchase price within the predefined period of time, deciding to sell locally generated power to reach the target state of charge at the time of the maximum price within the predefined period of time;
if the DRG system will not generate and store power to reach the target state of charge at the time of maximum utility power purchase price within the predefined period of time, determining whether the present utility power purchase price is greater than one or more projected selling prices;
if the present utility power purchase price is greater than one or more projected utility power purchase prices, deciding to sell locally generated power to the utility; and
if the present utility power purchase price is not greater than the one or more projected utility power purchase prices, deciding to store locally generated power in the batteries.

19. The computer program product of claim 18 wherein the target state of charge further comprises a state of charge above which charging of the batteries enters an absorption charging stage, the absorption charging stage comprising a charging stage during which charging current is reduced over time and charging voltage is held constant thereby reducing a rate at which locally generated power is stored in the batteries.

20. The computer program product of claim 16 further comprising computer program instructions capable of:
maintaining a DRG database of historical load and generation data, including tracking, in the DRG database, local present weather conditions, tracking, in the DRG database, local power generation and state of charge, and tracking, in the DRG database, a local load and local Alternating Current (‘AC’) production;
wherein creating the local load and generation profile for the predefined period of time further comprises retrieving projected weather conditions for the predefined period of time and selecting, from the DRG database, historical load and generation data for the predefined period of time beginning at the current time and the projected weather conditions.
